(19) United States
(12) Patent Application Publication
(10) Pub. No.: US 2024/0422640 A1
(43) Pub. Date: Dec. 19, 2024

(54) METHOD AND APPARATUS FOR WIRELESS COMMUNICATION

(71) Applicant: LENOVO (BEIJING) LIMITED, Beijing (CN)

(72) Inventors: Lianhai Wu, Beijing (CN); Prateek Basu Mallick, Dreieich (DE)

(21) Appl. No.: 18/701,425

(22) PCT Filed: Dec. 21, 2021
(86) PCT No.: PCT/CN2021/140108

§ 371 Date: Apr. 15, 2024

(51) Int. Cl. H04W 36/24; H04W 36/14; H04W 36/36

(52) U.S. Cl. CPC H04W 36/249; H04W 36/1443; H04W 36/362

(57) ABSTRACT

The present disclosure relates to methods and apparatuses for wireless communication. According to some embodiments of the disclosure, a method includes: receiving a first configuration message from a first RAN associated with a first SIM of a UE, wherein the first configuration message indicates a first value of a timer for leaving a connected state without a network response; determining to switch from the first RAN to a second RAN associated with a second SIM of the UE and leave the connected state in the first RAN; transmitting a UE assistant information message to the first RAN; and starting the timer according to the first value in response to the transmission of the UE assistant information message. According to some embodiments of the disclosure, a method for releasing a gap configuration is provided.

### TECHNICAL FIELD

The present disclosure generally relates to wireless communication technology, and more particularly to multi-SIM related operations in a wireless communication system.

### BACKGROUND

A user equipment (e.g., a cell phone, a tablet, a laptop, an internet-of-things (IoT) device, etc.), which may include two or more subscriber identity modules (SIMs), can be referred to as a multi-SIM UE.

Generally, a SIM may correspond to at least one subscription in an environment where radio access technology (RAT) is adopted. For example, a multi-SIM UE may have a first SIM associated with a first subscription and a second SIM associated with a second subscription. The first SIM and the second SIM can share the same hardware component(s), e.g., radio frequency (RF) component(s) or baseband component(s), which can impact the performance of a wireless communication system, such as LTE and 5G systems specified by the 3GPP (3rd Generation Partnership Project).

The industry desires technologies for facilitating the operations of a multi-SIM communication device in a communication system.

### SUMMARY

Some embodiments of the present disclosure provide a user equipment (UE). The UE may include: a first subscriber identity module (SIM); a second SIM; and a processor coupled to the first SIM and the second SIM. The processor may be configured to: receive a first configuration message from a first radio access network (RAN) associated with the first SIM, wherein the first configuration message indicates a first value of a timer for leaving a connected state without a network response; determine to switch from the first RAN to a second RAN associated with the second SIM and leave the connected state in the first RAN; transmit a UE assistant information message to the first RAN; and start the timer according to the first value in response to the transmission of the UE assistant information message.

Some embodiments of the present disclosure provide a user equipment (UE). The UE may include: a first subscriber identity module (SIM); a second SIM; and a processor coupled to the first SIM and the second SIM. The processor may be configured to: receive, from a first radio access network (RAN) associated with the first SIM, a reconfiguration message including a gap configuration, wherein the gap configuration indicates a time duration that the UE is maintained in a connected state in the first RAN while temporarily switching to a second RAN associated with the second SIM; and determine to release all gap configurations configured by the first RAN.

Some embodiments of the present disclosure provide a base station (BS). The BS may include: a transceiver; and a processor coupled to the transceiver. The processor may be configured to: receive, from a user equipment (UE), a UE assistant information message to release a gap configuration configured for the UE by a first RAN associated with the BS, wherein the gap configuration indicates a time duration that the UE is maintained in a connected state in the first RAN while temporarily switching to a second RAN; and transmit, to the UE, a reconfiguration message in response to the UE assistant information message.

Some embodiments of the present disclosure provide a method for wireless communication performed by a user equipment (UE). The method may include: receiving a first configuration message from a first radio access network (RAN) associated with a first SIM of the UE, wherein the first configuration message indicates a first value of a timer for leaving a connected state without a network response; determining to switch from the first RAN to a second RAN associated with a second SIM of the UE and leave the connected state in the first RAN; transmitting a UE assistant information message to the first RAN; and starting the timer according to the first value in response to the transmission of the UE assistant information message.

Some embodiments of the present disclosure provide a method for wireless communication performed by a user equipment (UE). The method may include: receiving, from a first radio access network (RAN) associated with a first SIM of the UE, a reconfiguration message including a gap configuration, wherein the gap configuration indicates a time duration that the UE is maintained in a connected state in the first RAN while temporarily switching to a second RAN associated with a second SIM of the UE; and determine to release all gap configurations configured by the first RAN.

Some embodiments of the present disclosure provide a method for wireless communication performed by a base station (BS). The method may include: receiving, from a user equipment (UE), a UE assistant information message to release a gap configuration configured for the UE by a first RAN associated with the BS, wherein the gap configuration indicates a time duration that the UE is maintained in a connected state in the first RAN while temporarily switching to a second RAN; and transmitting, to the UE, a reconfiguration message in response to the UE assistant information message.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary procedure of wireless communications in accordance with some embodiments of the present disclosure;

FIG. 3 illustrates a flow chart of an exemplary procedure of wireless communications in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments may be provided under a specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

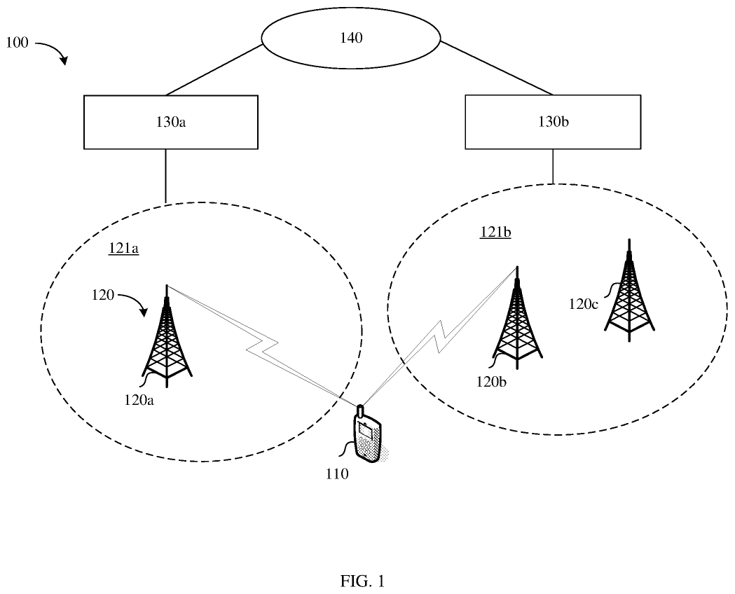

FIG. 1 illustrates a schematic diagram of a wireless communication system 100 in accordance with some embodiments of the present disclosure.

Referring to FIG. 1, a wireless communication system 100 may include some UEs (e.g., UE 110), some BSs 120 (e.g., BS 120a, BS 120b, and BS 120c), some RANs (e.g., RAN 121a and RAN 121b), some core networks (e.g., CN 130a and CN 130b), and a public switched telephone network (e.g., PSTN 140). It is contemplated that the wireless communication system 100 may include any number of UEs, BSs, networks, and/or network components.

BS 120 may operate, for example based on a standard protocol such as Long-Term Evolution (LTE), LTE-Advanced (LTE-A), New Radio (NR), or other suitable protocol(s). BS 120 may also be referred to as an access point, an access terminal, a base, a base unit, a macro cell, a Node-B, an evolved Node B (eNB), a gNB, a Home Node-B, a relay node, or a device, or described using other terminology used in the art. BS 120 may be any type of device configured to wirelessly interface with at least one UE (e.g., UE 110) to facilitate access to one or more communication networks, such as the CN 130a and CN 130b.

BS 120 is generally a part of a RAN that may include one or more controllers communicably coupled to one or more corresponding BSs. In the context of the present disclosure, “configured by a RAN can be interpreted” as configured by a BS associated with the RAN, or vice versa. For example, referring to FIG. 1, BS 120a may be part of RAN 121a, which may also include other BSs and/or network elements (not shown), such as a base station controller (BSC), a radio network controller (RNC), relay nodes, etc. BS 120b and BS 120c may be a part of RAN 121b that in addition to, may also include other BSs and/or network elements (not shown in FIG. 1). Each of the BS 120a, BS 120b, and BS 120c may be configured to transmit and/or receive wireless signals within a particular geographic region, which may be referred to as a cell (not shown in FIG. 1).

RAN 121a may be in communication with CN 130a, and RAN 121b may be in communication with CN 130b. RAN 121a and RAN 121b may employ the same or different radio access technologies (RATs). For example, RAN 121a may employ an evolved universal terrestrial radio access network (E-UTRAN) radio technology, and RAN 121b may employ an NR radio technology. For example, both RAN 121a and RAN 121b may employ the NR radio technology. Each of the CN 130a and CN 130b may include a plurality of core network components, such as a mobility management entity (MME) (not shown in FIG. 1) or an access and mobility management function (AMF) (not shown in FIG. 1). The CNs may serve as gateways for the UEs to access PTSN 140 and/or other networks (not shown in FIG. 1).

UE 110 may be any type of device configured to operate and/or communicate in a wireless environment. For example, UE 110 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 110 includes wearable devices, such as smart watches, fitness bands, optical head-mounted displays, or the like. Moreover, UE 110 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 110 may communicate with BS 120 via uplink (UL) communication signals. BS 102 may communicate with UE 110 via downlink (DL) communication signals.

UE 110 may include one or more subscriber identity modules (SIMs) that enable it to access one or more separate wireless communication networks. As shown in FIG. 1, UE 110 may be configured to access either RAN 121a through BS 120a by virtue of SIM #1 (not shown in FIG. 1) in UE 110 or RAN 121b through BS 120b by virtue of SIM #2 (not shown in FIG. 1) in UE 110. While UE 110 is shown accessing RAN 121a and RAN 121b, in other examples (not shown), the UE 110 may establish additional network connections using additional RATs.

Each of SIM #1 and SIM #2 may be associated with a kind of wireless communication system. For example, either SIM #1 and SIM #2 may be represented by a SIM card corresponding to a GSM system, a universal subscriber identity module (USIM) card corresponding to a UMTS system, a removable user identity module (RUIM) card or a CDMA subscriber identity module (CSIM) card corresponding to the CDMA2000 communication system, a universal integrated circuit card (UICC) corresponding to 5G (NR) communication system, a wireless network card corresponding to IEEE 802.11x wireless local area network (WLAN), or other suitable modules that can identify the subscribers.

A multi-SIM UE may be implemented as a multi-SIM-single-standby (MSSS) UE, a multi-SIM-multi-standby (MSMS) UE, a multi-SIM-multi-active (MSMA) UE, etc.

For example, a UE that includes a plurality of SIMs and connects to two or more networks with two or more SIMs being active at a given time may be referred to as an MSMA UE. An example MSMA UE may be a dual-SIM-dual-active (DSDA) UE, which may include two SIMs. Both SIMs of a DSDA UE may remain active. For example, a UE provided with a plurality of SIMs and connected to two or more networks with one SIM being active at a given time may be referred to as an MSMS UE. An example of the MSMS UE may be a dual-SIM-dual-standby (DSDS) UE. A DSDS UE may include two SIMs, and may use a single radio front-end and baseband to register the communication device to a single (the same) public land mobile network or to two different PLMNs with the two SIMs, respectively.

In a multi-SIM UE, the plurality of SIMs may share a common set of radio frequency (RF) resources (such as a RF transceiver) of the UE. However, embodiments described herein may also be applicable to a multi-SIM UE in which each of the plurality of SIMs is associated with a separate RF resource.

In some embodiments of the present disclosure, a multi-SIM UE in a connected state (e.g., RRC_CONNECTED state as specified in 3GPP specifications) in a network A may switch from network A to network B. For example, network A may be an NR system and network B may be an E-UTRA system or an NR system. For instance, referring to FIG. 1, UE 110 may be in a connected state in RAN 121a and may switch from RAN 121a to RAN 121b to, for example, receive a service in RAN 121b. Before switching from network A to network B, a multi-SIM UE should notify network A that the UE is to leave the connected state in network A, for example, switch to an inactive or idle state (e.g., RRC_INACTIVE state or RRC_IDLE state as specified in 3GPP specifications), or the UE is to be kept in the connected state in network A. Such notification can be transmitted via a UE assistance information message, which will be described in detail below.

In some embodiments of the present disclosure, a multi-SIM UE can signal the network A the preference to leave a connected state by radio resource control (RRC) signaling or non-access stratum (NAS) signaling when the UE is configured to do so. After the UE transmits the preference to leave the connected state by, for example, RRC signaling, in the case that the UE does not receive an RRC Release message from network A within a certain time period (if configured by network A), the UE can autonomously enter an idle state in network A. The certain time period may be configured by an RRC reconfiguration message (e.g., indicated by MUSIM-LeaveWithoutResponseTimer information element (IE)).

In some embodiments of the present disclosure, a multi-SIM UE can signal network A the preference to be kept in the connected state in network A while temporarily switching to network B, which can be indicated by scheduling a gap preference. The gap preference can include information for the setup or release of gaps.

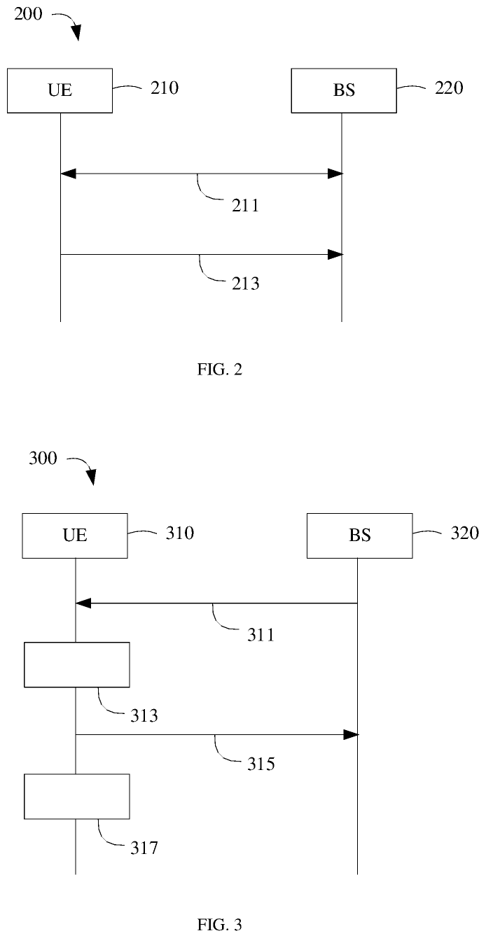

FIG. 2 illustrates a flow chart of an exemplary procedure 200 of wireless communications in accordance with some embodiments of the present disclosure. Details described in all of the foregoing embodiments of the present disclosure are applicable for the embodiments shown in FIG. 2. It should be appreciated by persons skilled in the art that the sequence of the operations in exemplary procedure 200 may be changed and some of the operations in exemplary procedure 200 may be eliminated or modified, without departing from the spirit and scope of the disclosure.

Referring to FIG. 2, UE 210 and BS 220 may function as UE 110 and BS 120 shown in FIG. 1, respectively. In operation 211, UE 210 and BS 220 may interact to perform an RRC reconfiguration operation involving UE 210. For example, BS 220 may transmit an RRC reconfiguration message to UE 210. The RRC reconfiguration message may indicate UE 210 to report assistant information to BS 220. Under certain scenarios, UE 210 may, in operation 213, transmit a UE assistance information message to BS 220.

For example, the UE may use the UE assistance information message to inform the network of the following information:
its delay budget report carrying desired increment/decrement in the connected mode discontinuous reception (DRX) cycle length;
its overheating assistance information;
its in-device coexistence (IDC) assistance information;
its preference on DRX parameters for power saving;
its preference on the maximum aggregated bandwidth for power saving;
its preference on the maximum number of secondary component carriers for power saving;
its preference on the maximum number of multiple-input and multiple-output (MIMO) layers for power saving;
its preference on the minimum scheduling offset for cross-slot scheduling for power saving;
its preference on the RRC state;
configured grant assistance information for NR sidelink communication;
its preference in being provisioned with reference time information;
its multi-SIM (e.g., multiple USIM (MUSIM)) assistance information; or
any combination thereof.

In some embodiments of the present disclosure, a UE capable of providing multi-SIM assistance information may initiate the above procedure (e.g., if the UE is configured to do so) in response to determining to leave a connected state or that it needs a gap(s), or in response to, for example, a change of the gap information without leaving the connected state.

In some embodiments of the present disclosure, a UE may be configured with a conditional handover (CHO) configuration via, for example, an RRC reconfiguration message. The CHO configuration may be associated with at least one execution condition for at least one candidate node. The candidate node for CHO may be either a relay node or a cell. Each candidate node of the at least one candidate node may be associated with one or more execution conditions. The execution condition may be generated by a source BS of the UE. The CHO configuration may include a configuration of the candidate node generated by the candidate BS (e.g., a BS of the candidate cell or a BS serving the candidate relay node).

In some embodiments of the present disclosure, the UE may start evaluating the at least one execution condition in response to receiving the CHO configuration. In response to an execution condition for a candidate node being met, the UE may select the candidate node as a target node and may initiate a CHO procedure with the target node. The UE may stop evaluating the execution condition during the CHO execution or initiation of the CHO procedure.

Embodiments of the present disclosure propose technical solutions for facilitating the operations of a multi-SIM UE. For example, how to manage the impact of a multi-SIM related timer on the operations of a UE. For instance, when such a timer is running and a CHO condition is met or a handover command is received, how the UE behaves. For instance, when such a timer is running and a reconfiguration message is received, how the UE behaves. In addition, solutions for releasing the gap configurations (e.g., all gap configurations) are also provided. More details on the embodiments of the present disclosure will be illustrated in the following text in combination with the appended drawings.

FIG. 3 illustrates a flow chart of an exemplary procedure 300 of wireless communications in accordance with some embodiments of the present disclosure. Details described in all of the foregoing embodiments of the present disclosure are applicable for the embodiments shown in FIG. 3.

Referring to FIG. 3, UE 310 and BS 320 may function as UE 110 and BS 120 shown in FIG. 1, respectively. UE 310 may include SIM #3A and SIM #3B. UE 310 may access a network (denoted as “network #3A”) via BS 320 and may be in a connected state in network #3A. UE 310 may be in an idle or inactive state in another network (denoted as “network #3B”). Network #3A and network #3B may be associated with SIM #3A and SIM #3B, respectively. For example, UE 310 may access network #3A via SIM #3A, and access network #3B via SIM #3B.

In operation 311, UE 310 may receive a configuration message (e.g., an RRC reconfiguration message) from BS 320 (or network #3A). In some embodiments of the present disclosure, the configuration message may configure a CHO configuration for UE 310. An RRC reconfiguration message including a reconfigurationwithsync IE can be associated with a CHO configuration and a normal handover command.

In some embodiments of the present disclosure, the configuration message may indicate a UE to report assistance information. For example, the network can inform the UE that multi-SIM operations are supported by the network. The assistance information described above may apply here. For example, the assistance information may be indicated in a musim-AssistanceConfig IE as specified in 3GPP specifications.

In some embodiments of the present disclosure, the configuration message may configure a timer for leaving a connected state without network response for UE 310. For example, the configuration message may indicate a value for such timer. When the timer expires, the UE can autonomously leave the connected state and enter an idle state in network #3A for the purpose of multi-SIM operations. For example, the timer can be indicated by a musim-LeaveWithoutResponseTimer IE as specified in 3GPP specifications.

In operation 313, UE 310 may determine to leave the connected state in network #3A. UE 310 may make such determination when, for example, it receives a paging message from network #3B, wants to transmit a busy indication to network #3B, or wants to receive system information from network #3B.

In operation 315, UE 310 may transmit a UE assistance information message to BS 320. In some embodiments of the present disclosure, UE 310 may be configured to provide multi-SIM related assistance information. The UE assistance information message may include the multi-SIM related assistance information. The UE assistance information message may indicate that the UE has determined to leave the connected state in network #3A.

In some embodiments of the present disclosure, UE 310 may be configured with a value of the timer for leaving a connected state without a network response. In response to the transmission of the UE assistant information message, UE 310 may start the timer according to the configured value. In response to the expiry of the timer for leaving without a network response, UE 310 may autonomously leave the connected state and enter the idle state in network #3A.

In some embodiments of the present disclosure, UE 310 may, in operation 317, determine that a CHO execution condition for a target node is met. UE 310 may determine whether the timer for leaving without a network response is running in response to the CHO execution condition being met.

In some embodiments of the present disclosure, UE 310 may initiate a CHO procedure with the target node in response to the timer running when the execution condition for the target node is met. In some examples, UE 310 may further perform one of the following: in response to the CHO configuration associated with the target node indicating a value of the timer, restarting the timer according to the timer value in the CHO configuration; in response to the CHO configuration associated with the target node not indicating a value of the timer, stopping the timer; or continuing the timer (e.g., no action to the timer). In response to a successful CHO, UE 310 may stop all timers that are running except, for example, the de-prioritization timer (e.g., timer T325 as specified in 3GPP specifications), the logging duration timer (e.g., timer T330 as specified in 3GPP specifications), the sidelink reconfiguration timer (e.g., T400 as specified in 3GPP specifications), and the timer for leaving without a network response. That is, UE 310 may continue the timer for leaving without a network response if it is running even after switching to the target node.

In some examples, UE 310 may stop the timer for leaving without a network response in response to the timer running when the CHO execution condition for the target node is met. UE 310 may transmit a UE assistance information message to the target node based on the configuration from the target node (e.g., the CHO configuration associated with the target node) after successfully handing over to the target node. For example, in response to a successful CHO, UE 310 may transmit a UE assistance information message to the target node if the target node supports this function. The UE assistance information may indicate that UE 310 has decided to leave the connected state.

In some embodiments of the present disclosure, UE 310 may not perform a CHO procedure with the target node in response to the timer for leaving without a network response running when the execution condition for the target node is met. For example, UE 310 may not initiate a CHO procedure with the target node. In some embodiments of the present disclosure, UE 310 may stop evaluating the at least one CHO execution condition in the CHO configuration in response to the start of the timer for leaving without a network response. In some examples, UE 310 may stop triggering the measurement report in response to the start of the timer.

In some embodiments of the present disclosure, UE 310 may, in operation 317, receive a handover (HO) command to switch to a target node. The UE may determine whether the timer for leaving without a network response is running in response to the reception of the HO command.

In some embodiments of the present disclosure, UE 310 may initiate an HO procedure with the target node in response to the timer running when receiving the HO command. In some examples, UE 310 may further perform one of the following: in response to the UE being configured with a value of the timer by the target node (e.g., in the HO command), restarting the timer according to the timer value configured by the target node; in response to the UE not being configured with a value of the timer by the target node, stopping the timer; or continuing the timer (e.g., no action to the timer). In response to a successful HO, UE 310 may stop all timers that are running except, for example, the de-prioritization timer (e.g., timer T325 as specified in 3GPP specifications), the logging duration timer (e.g., timer T330 as specified in 3GPP specifications), the sidelink reconfiguration timer (e.g., T400 as specified in 3GPP specifications), and the timer for leaving without a network response. That is, UE 310 may continue the timer for leaving without a network response if it is running even after switching to the target node.

In some examples, UE 310 may stop the timer for leaving without a network response in response to the timer running when receiving the HO command. UE 310 may transmit a UE assistance information message to the target node based on the configuration from the target node (e.g., the HO command) after successfully handing over to the target node. For example, in response to a successful HO, UE 310 may transmit a UE assistance information message to the target node if the target node supports this function. The UE assistance information may indicate that UE 310 has decided to leave the connected state.

In some embodiments of the present disclosure, UE 310 may not perform an HO procedure with the target node in response to the timer for leaving without a network response running when receiving the HO command. For example, UE 310 may not ignore the HO command.

It should be appreciated by persons skilled in the art that the sequence of the operations in exemplary procedure 300 may be changed and some of the operations in exemplary procedure 300 may be eliminated or modified, without departing from the spirit and scope of the disclosure.

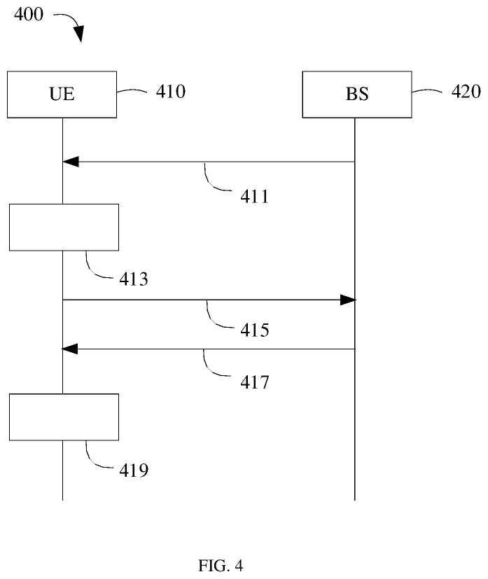

FIG. 4 illustrates a flow chart of an exemplary procedure 400 of wireless communications in accordance with some embodiments of the present disclosure. Details described in all of the foregoing embodiments of the present disclosure are applicable for the embodiments shown in FIG. 4.

Referring to FIG. 4, UE 410 and BS 420 may function as UE 110 and BS 120 shown in FIG. 1, respectively. UE 410 may include SIM #4A and SIM #4B. UE 410 may access a network (denoted as “network #4A”) via BS 420 and may be in a connected state in network #4A. UE 410 may be in an idle or inactive state in another network (denoted as “network #4B”). Network #4A and network #4B may be associated with SIM #4A and SIM #4B, respectively. For example, UE 410 may access network #4A via SIM #4A, and access network #4B via SIM #4B.

In operation 411, UE 410 may receive a configuration message (e.g., an RRC reconfiguration message) from BS 420 (or network #4A). In some embodiments of the present disclosure, the configuration message may indicate a UE to report assistance information. For example, the network can inform the UE that multi-SIM operations are supported by the network. The assistance information described above may apply here. For example, the assistance information may be indicated in a musim-AssistanceConfig IE as specified in 3GPP specifications. In some embodiments of the present disclosure, the configuration message may configure a CHO configuration for UE 410.

In some embodiments of the present disclosure, the configuration message may configure a timer for leaving a connected state without network response for UE 410. For example, the configuration message may indicate a value for such timer. When the timer expires, the UE can autonomously leave the connected state and enter an idle state in network #4A for the purpose of multi-SIM operations. For example, the timer can be indicated by a musim-LeaveWithoutResponseTimer IE as specified in 3GPP specifications.

In operation 413, UE 410 may determine to leave the connected state in network #4A. UE 410 may make such determination when, for example, it receives a paging message from network #4B, wants to transmit a busy indication to network #4B, or wants to receive system information from network #4B.

In operation 415, UE 410 may transmit a UE assistance information message to BS 420. In some embodiments of the present disclosure, UE 410 may be configured to provide multi-SIM related assistance information. The UE assistance information message may include the multi-SIM related assistance information. The UE assistance information message may indicate that the UE has determined to leave the connected state in network #4A.

In some embodiments of the present disclosure, UE 410 may be configured with a value of the timer for leaving a connected state without a network response. In response to the transmission of the UE assistant information message, UE 410 may start the timer according to the configured value.

In some embodiments of the present disclosure, UE 410 may, in operation 417, receive another configuration message (e.g., an RRC reconfiguration message) from BS 420 (or network #4A). UE 310 may determine whether the timer for leaving without a network response is running in response to the reception of the another configuration message.

In some examples, in response to the another configuration message indicating a value of the timer for leaving without a network response, UE 410 may, in operation 419, restart the timer for leaving without a network response according to the time value in the another configuration message. In some examples, in response to the another configuration message not indicating a value of the timer for leaving without a network response, UE 410 may, in operation 419, stop the timer.

In response to the expiry of the timer for leaving without a network response, UE 410 may autonomously leave the connected state and enter the idle state in network #4A. In response to the reception of an RRC release message from BS 320, UE 410 may leave the connected state and enter the idle state in network #4A.

It should be appreciated by persons skilled in the art that the sequence of the operations in exemplary procedure 400 may be changed and some of the operations in exemplary procedure 400 may be eliminated or modified, without departing from the spirit and scope of the disclosure.

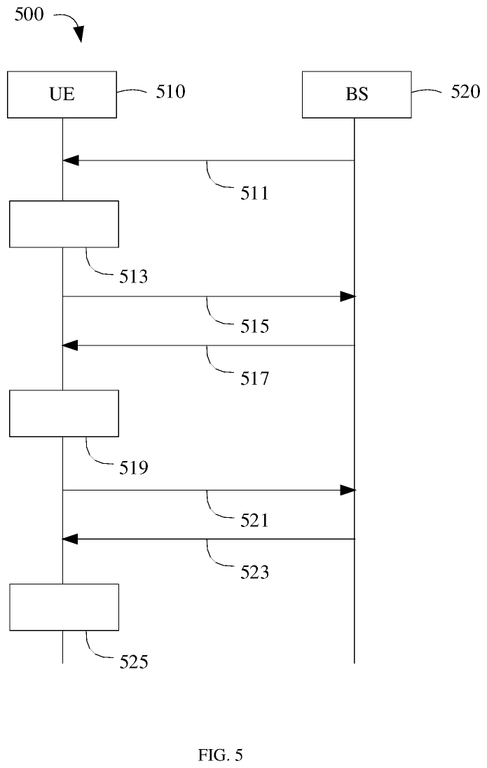

FIG. 5 illustrates a flow chart of an exemplary procedure 500 of wireless communications in accordance with some embodiments of the present disclosure. Details described in all of the foregoing embodiments of the present disclosure are applicable for the embodiments shown in FIG. 5.

Referring to FIG. 5, UE 510 and BS 520 may function as UE 110 and BS 120 shown in FIG. 1, respectively. UE 510 may include SIM #5A and SIM #5B. UE 510 may access a network (denoted as “network #5A”) via BS 520 and may be in a connected state in network #5A. UE 510 may be in an idle or inactive state in another network (denoted as “network #5B”). Network #5A and network #5B may be associated with SIM #5A and SIM #5B, respectively. For example, UE 510 may access network #5A via SIM #5A, and access network #5B via SIM #5B.

In operation 511, UE 510 may receive a configuration message (e.g., an RRC reconfiguration message) from BS 520 (or network #5A). In some embodiments of the present disclosure, the configuration message may indicate a UE to report assistance information. For example, the network can inform the UE that multi-SIM operations are supported by the network. The assistance information described above may apply here. For example, the assistance information may be indicated in a musim-AssistanceConfig IE as specified in 3GPP specifications.

In some embodiments of the present disclosure, the configuration message may configure a timer for leaving a connected state without network response for UE 510. For example, the configuration message may indicate a value for such timer. When the timer expires, the UE can autonomously leave the connected state and enter an idle state in network #5A for the purpose of multi-SIM operations. For example, the timer can be indicated by a musim-LeaveWithoutResponseTimer IE as specified in 3GPP specifications. In some embodiments of the present disclosure, the configuration message may configure a CHO configuration for UE 510.

In operation 513, UE 510 may determine to stay in the connected state in network #5A while temporarily switching to network #5B. UE 510 may make such determination when, for example, it receives a paging message from network #5B, wants to transmit a busy indication to network #5B, or wants to receive system information from network #5B.

In operation 515, UE 510 may transmit a UE assistance information message to BS 520. In some embodiments of the present disclosure, UE 510 may be configured to provide multi-SIM related assistance information. The UE assistance information message may include the multi-SIM related assistance information. The UE assistance information message may indicate that the UE has determined to maintain the connected state in network #5A while temporarily switching to network #5B.

In some examples, the UE assistance information message may include gap information to indicate a preference(s) on a multi-SIM gap(s) of UE 510. For instance, the UE assistance information message may include a gap request list for a multi-SIM operation (e.g., musim-GapRequestList as specified in 3GPP specifications). For instance, the UE assistance information message may indicate a gap offset (e.g., musim-GapOffset as specified in 3GPP specifications), a gap length (e.g., musim-GapLength-r17 as specified in 3GPP specifications), a gap repetition period (e.g., musim-GapRepetitionPeriod-r17 as specified in 3GPP specifications), or any combination thereof.

In operation 517, UE 510 may receive a gap configuration from BS 520. The gap configuration may indicate the time duration that UE 510 is maintained in a connected state in network #5A while temporarily switching to another network (e.g., network #5B). The gap configuration may be carried by an RRC reconfiguration message. UE 510 may then switch to network #5B according to the gap configuration.

In operation 519, UE 510 may determine to release the gap configuration after, for example, completing the reception of system information or paging message or the transmission of a busy indication in network #5B. In response to such determination, UE 510 may transmit a UE assistant information message to BS 520 in operation 521.

In some embodiments of the present disclosure, UE 510 may determine to release all gap configurations configured by BS 520 (or network #5A). In some examples, the UE assistant information message may include a preferred state indicator indicating a connected state (e.g., musim-PreferredRRC-State setting as “connected” as specified in 3GPP specifications) and may not include a gap request list. In the case that UE 510 wants to maintain at least one gap configuration, UE 510 may include a gap request list, which may indicate the gap configuration(s) that UE 510 intends to release or keep.

In some examples, the UE assistant information message may include a gap-related indicator set as a predefined value for releasing all gap configurations. For instance, UE 510 may set a gap offset to indicate “infinity,” or a gap length to indicate “zero.”

In operation 523, in response to the UE assistant information message, BS 520 may transmit another reconfiguration message to UE 510. The reconfiguration message may indicate to release all gap configurations configured by BS 520 (or network #5A) in response to the received UE assistant information message including a preferred state indicator indicating a connected state and does not include a gap request list, or in response to the UE assistant information message including a gap-related indicator set as a predefined value for releasing all gap configurations. The reconfiguration message may indicate to release all gap configurations by not including any gap information or configuration.

In operation 525, UE 510 may release a gap configuration in response to the reception of the another reconfiguration message. For example, in response to the another reconfiguration message indicating to release all gap configurations, UE 510 may release all gap configurations configured by BS 520 (or network #5A).

It should be appreciated by persons skilled in the art that the sequence of the operations in exemplary procedure 500 may be changed and some of the operations in exemplary procedure 500 may be eliminated or modified, without departing from the spirit and scope of the disclosure.

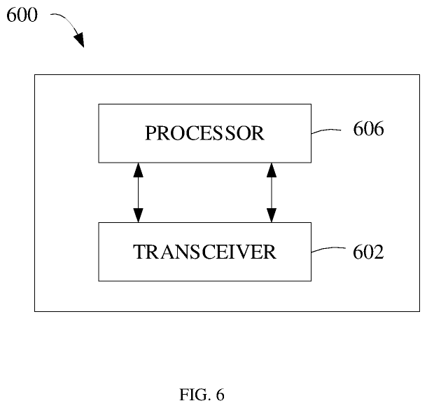

FIG. 6 illustrates a block diagram of an exemplary apparatus 600 according to some embodiments of the present disclosure. As shown in FIG. 6, the apparatus 600 may include at least one processor 606 and at least one transceiver 602 coupled to the processor 606. The apparatus 600 may be a UE or a BS.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a UE. The transceiver 602 and the processor 606 may interact with each other so as to perform the operations with respect to the UE described above, for example, in FIGS. 1-5.

In some embodiments of the present application, the apparatus 600 may be a BS. The transceiver 602 and the processor 606 may interact with each other so as to perform the operations with respect to the BS described above, for example, in FIGS. 1-5.

In some embodiments of the present application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to the UE as described above. For example, the computer-executable instructions, when executed, cause the processor 606 interacting with transceiver 602 to perform the operations with respect to the UE described in FIGS. 1-5.

In some embodiments of the present application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to the BS as described above. For example, the computer-executable instructions, when executed, cause the processor 606 interacting with transceiver 602 to perform the operations with respect to the BS described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a first configuration message from a first radio access network (RAN) associated with a first subscriber identity module (SIM), wherein the first configuration message indicates a first value of a timer for leaving a connected state without a network response;
determine to switch from the first RAN to a second RAN associated with a second SIM and leave the connected state in the first RAN;
transmit a UE assistant information message to the first RAN; and
start the timer according to the first value in response to the transmission of the UE assistant information message.

2. The UE of claim 1, wherein the at least one processor is configured to cause the UE to:
receive, from the first RAN, a conditional handover (CHO) configuration associated with at least one execution condition for at least one candidate node;
in response to the timer running when an execution condition for a target node is met, initiate a CHO procedure with the target node and perform one of the following:
in response to the CHO configuration associated with the target node indicating a second value of the timer, restarting the timer according to the second value;
in response to the CHO configuration associated with the target node not indicating a value of the timer, stopping the timer;
continuing the timer; or
stopping the timer.

3. The UE of claim 1, wherein the at least one processor is configured to cause the UE to:
receive, from the first RAN, a conditional handover (CHO) configuration associated with at least one execution condition for at least one candidate node; and
in response to the timer running when an execution condition for a target node is met, not initiate a CHO procedure with the target node.

4. The UE of claim 1, wherein the at least one processor is configured to cause the UE to:
receive, from the first RAN, a conditional handover (CHO) configuration associated with at least one execution condition for at least one candidate node; and
in response to the start of the timer, stop evaluating the at least one execution condition.

5. The UE of claim 1, wherein the at least one processor is configured to cause the UE to:
receive a handover (HO) command to switch to a target node;
in response to the timer running when receiving the HO command, initiate a HO procedure and perform one of the following:
in response to the UE being configured with a second value of the timer by the target node, restarting the timer according to the second value;
in response to the UE being not configured with a value of the timer by the target node, stopping the timer;
continuing the timer; or
stopping the timer.

6. The UE of claim 1, wherein the at least one processor is configured to cause the UE to:
receive a handover (HO) command to switch to a target node; and
in response to the timer running when receiving the HO command, ignore the HO command.

7. The UE of claim 2, wherein in response to a successful CHO or HO, the at least one processor is configured to cause the UE to continue the timer when the timer is running.

8. The UE of claim 1, wherein the at least one processor is configured to cause the UE to:
receive a second configuration message from the first RAN when the timer is running; and
in response to the second configuration message indicating a second value of the timer, restart the timer according to the second value, or in response to the second configuration message not indicating a value of the timer, stop the timer.

9. A user equipment (UE), comprising:
at least one memory; and
at least one processor coupled with the at least one memory and configured to cause the UE to:
receive, from a first radio access network (RAN) associated with a first subscriber identity module (SIM), a reconfiguration message including a gap configuration, wherein the gap configuration indicates a time duration that the UE is maintained in a connected state in the first RAN while temporarily switching to a second RAN associated with a second SIM; and
determine to release all gap configurations configured by the first RAN.

10. The UE of claim 9, wherein the at least one processor is configured to cause the UE to:
transmit a UE assistant information message to the first RAN to release the gap configuration,
wherein the UE assistant information message includes a preferred state indicator indicating a connected state and does not include a gap request list, or
wherein the UE assistant information message includes a gap-related indicator set as a predefined value for releasing all gap configurations configured by the first RAN.

11. The UE of claim 10, wherein the gap-related indicator is a gap offset indicator set as infinity, or a gap length indicator set as a zero gap length.

12. The UE of claim 10, wherein the at least one processor is configured to cause the UE to:
receive another reconfiguration message which indicates to release all gap configurations in response to the UE assistant information message; and
release all gap configurations configured by the first RAN in response to the reception of the another reconfiguration message.

13. A base station (BS), comprising:
at least one memory; and
at least one processor coupled with the at least one memory and configured to cause the base station to:
receive, from a user equipment (UE), a UE assistant information message to release a gap configuration configured for the UE by a first RAN associated with the BS, wherein the gap configuration indicates a time duration that the UE is maintained in a connected state in the first RAN while temporarily switching to a second RAN; and
transmit, to the UE, a reconfiguration message in response to the UE assistant information message.

14. The BS of claim 13, wherein in response to the UE assistant information message including a preferred state indicator indicating a connected state and does not include a gap request list, or in response to the UE assistant information message including a gap-related indicator set as a predefined value for releasing all gap configurations configured by the first RAN, the reconfiguration message indicates to release all gap configurations.

15. The BS of claim 14, wherein the gap-related indicator is a gap offset indicator set as infinity, or a gap length indicator set as a zero gap length.

16. A processor for wireless communication, comprising:
at least one controller coupled with at least one memory and configured to cause the processor to:
receive a first configuration message from a first radio access network (RAN) associated with a first subscriber identity module (SIM), wherein the first configuration message indicates a first value of a timer for leaving a connected state without a network response;
determine to switch from the first RAN to a second RAN associated with a second SIM and leave the connected state in the first RAN;
transmit a UE assistant information message to the first RAN; and
start the timer according to the first value in response to the transmission of the UE assistant information message.

17. The processor of claim 16, wherein the at least one controller is configured to cause the UE to:
receive, from the first RAN, a conditional handover (CHO) configuration associated with at least one execution condition for at least one candidate node;
in response to the timer running when an execution condition for a target node is met, initiate a CHO procedure with the target node and perform one of the following:
in response to the CHO configuration associated with the target node indicating a second value of the timer, restarting the timer according to the second value;
in response to the CHO configuration associated with the target node not indicating a value of the timer, stopping the timer;
continuing the timer; or
stopping the timer.

18. The processor of claim 16, wherein the at least one controller is configured to cause the UE to:
receive, from the first RAN, a conditional handover (CHO) configuration associated with at least one execution condition for at least one candidate node; and
in response to the timer running when an execution condition for a target node is met, not initiate a CHO procedure with the target node.

19. The processor of claim 16, wherein the at least one controller is configured to cause the UE to:
receive, from the first RAN, a conditional handover (CHO) configuration associated with at least one execution condition for at least one candidate node; and
in response to the start of the timer, stop evaluating the at least one execution condition.

20. The processor of claim 16, wherein the at least one controller is configured to cause the UE to:
receive a handover (HO) command to switch to a target node;
in response to the timer running when receiving the HO command, initiate a HO procedure and perform one of the following:
in response to the UE being configured with a second value of the timer by the target node, restarting the timer according to the second value;
in response to the UE being not configured with a value of the timer by the target node, stopping the timer;
continuing the timer; or
stopping the timer.
